(19) United States
(12) Patent Application Publication
(10) Pub. No.: US 2025/0223853 A1
(43) Pub. Date: Jul. 10, 2025

(54) HINGE LEAF COVER

(71) Applicant: Eric Nelson, West Haven, UT (US)

(72) Inventor: Eric Nelson, West Haven, UT (US)

(21) Appl. No.: 18/408,425

(22) Filed: Jan. 9, 2024

(51) Int. Cl. E05D 11/00

(52) U.S. Cl. CPC E05D 11/0054

(57) ABSTRACT

Hinge leaf covers can be used to mask hinges while painting. A hinge leaf cover can be configured to be selectively secured overtop the knuckle components of a hinge leaf to cover the remainder of the hinge leaf during painting. The hinge leaf cover can then be removed and reused if desired.

### CROSS-REFERENCE TO RELATED APPLICATIONS

N/A

### BACKGROUND

When doors and door frames are painted, the hinges are oftentimes already installed. It is therefore necessary to tape off the hinges to prevent them from being painted. This can be a very tedious process.

### BRIEF SUMMARY

The present disclosure is directed to hinge leaf covers that can be used to mask hinges while painting. A hinge leaf cover configured in accordance with embodiments of the present disclosure can be configured to be selectively secured overtop the knuckle components of a hinge leaf to cover the remainder of the hinge leaf during painting. The hinge leaf cover can then be removed and reused if desired.

In some embodiments of the present disclosure, a hinge leaf cover may include a knuckle portion that is configured to be secured to one or more knuckle components of a hinge leaf and a leaf portion that extends from the knuckle portion and is configured to cover the hinge leaf.

In some embodiments of the present disclosure, a hinge leaf cover may include a knuckle portion and a leaf portion that extends from the knuckle portion. The knuckle portion includes an extension that is spaced from the leaf portion to form a channel.

In some embodiments of the present disclosure, a paint masking solution may include a left-hand hinge leaf cover for masking a left-hand hinge leaf of a hinge and a right-hand hinge leaf cover for masking a right-hand hinge leaf of the hinge. The left-hand hinge leaf cover includes a knuckle portion configured to be secured to one or more knuckle components of the left-hand hinge leaf and a leaf portion that extends from the knuckle portion. The right-hand hinge leaf cover includes a knuckle portion configured to be secured to one or more knuckle components of the right-hand hinge leaf and a leaf portion that extends from the knuckle portion.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a front perspective view of a hinge leaf cover that is configured in accordance with one or more embodiments of the present disclosure;

FIG. 2 is a bottom view of the hinge leaf cover of FIG. 1;

FIG. 3 is a top view of the hinge leaf cover of FIG. 1;

FIG. 4 is a left side view of the hinge leaf cover of FIG. 1;

FIG. 5 is a right side view of the hinge leaf cover of FIG. 1;

FIG. 6 is a front view of the hinge leaf cover of FIG. 1;

FIG. 7 is a rear view of the hinge leaf cover of FIG. 1;

FIG. 8 is a front perspective view of a hinge leaf cover that is a mirror image of the hinge leaf cover of FIG. 1; and

FIG. 9 provides an example of how the hinge leaf cover of FIG. 1 can be secured overtop the knuckle components of a hinge leaf to cover the hinge leaf.

### DETAILED DESCRIPTION

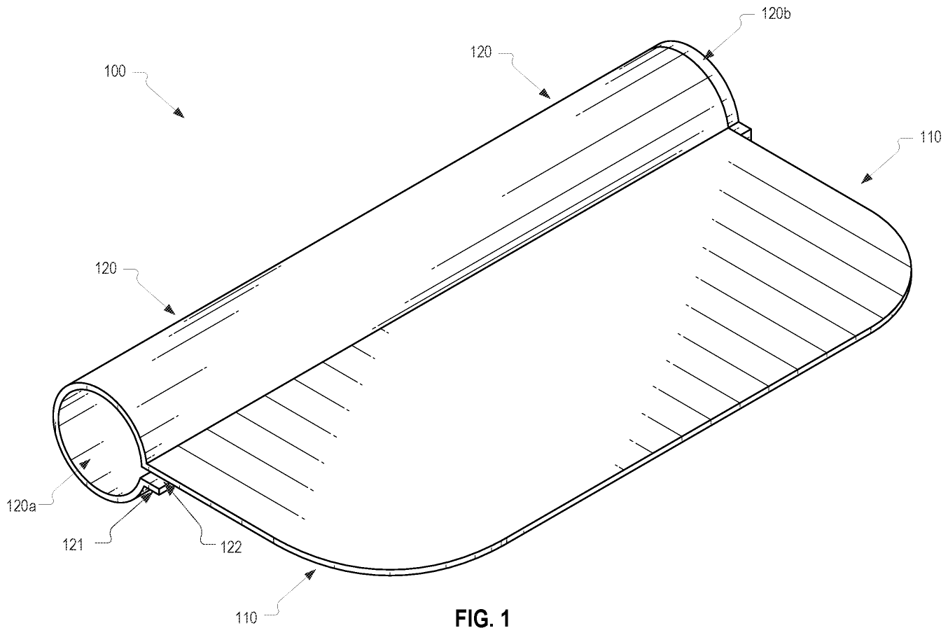

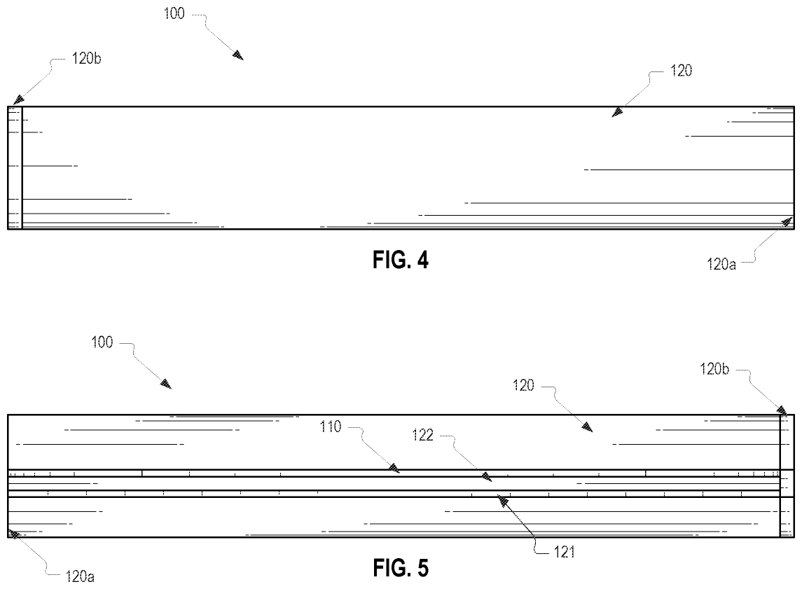

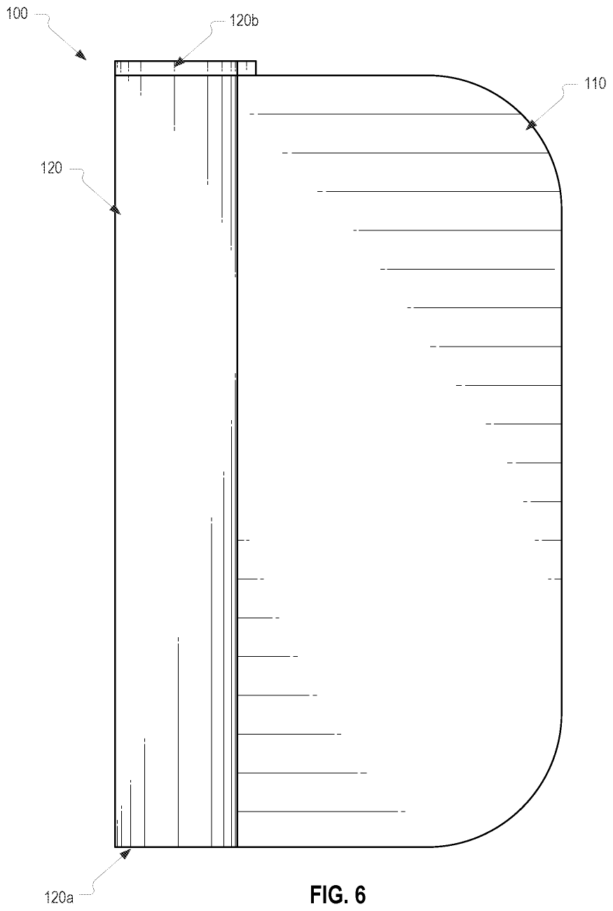

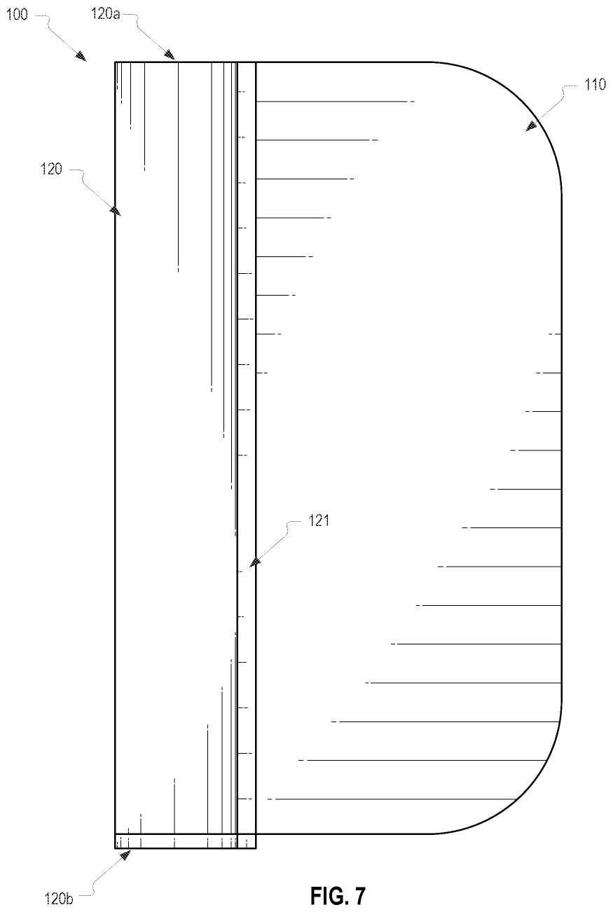

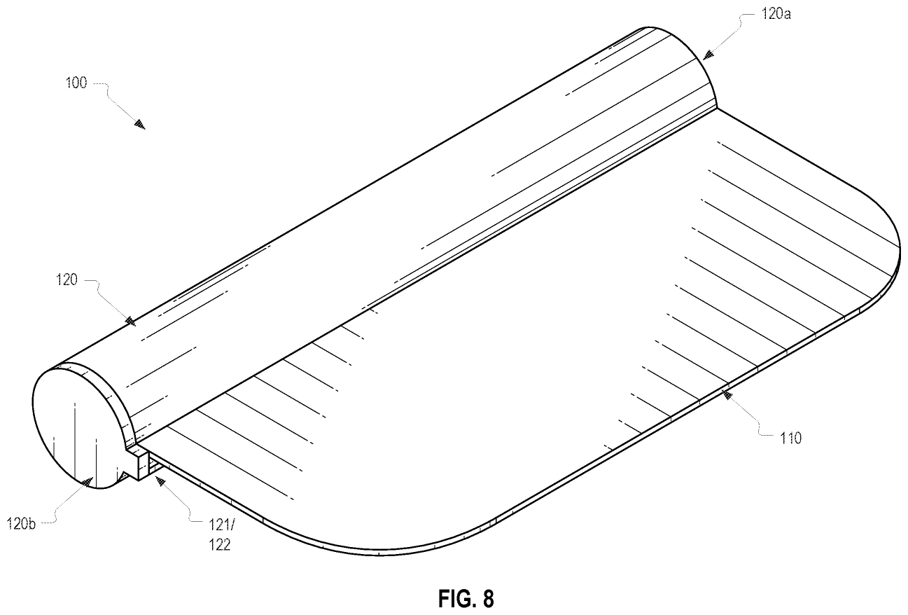

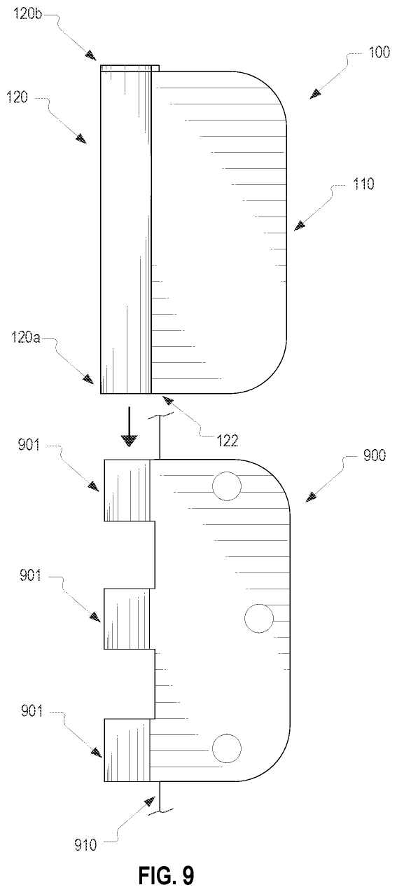

FIGS. 1-7 are various views of a hinge leaf cover 100 that is configured in accordance with embodiments of the present invention. In these figures, hinge leaf cover 100 is configured for a left-hand hinge leaf. In contrast, in FIG. 8, hinge leaf cover 100 is configured for a right-hand hinge leaf and is therefore a mirror image of hinge leaf cover 100 in FIGS. 1-7. FIG. 9 provides an example of how hinge leaf cover 100 can be secured to a hinge leaf 900 having knuckle components 901.

Hinge leaf cover 100 includes a leaf portion 110 and a knuckle portion 120. Knuckle portion 120 is configured to be positioned overtop (or at least partially around) the knuckle components of a hinge leaf. In some embodiments, such as the depicted embodiments, knuckle portion 120 may be a cylinder having a height that generally matches the height of the hinge leaf. In other embodiments, knuckle portion 120 could have a shorter height such as a height sufficient to cover the knuckle components when the knuckle components do not extend along the full height of the hinge leaf. In some embodiments, knuckle portion 120 could have an inner diameter (or width or other measurement) that substantially matches the outer diameter of the knuckle components so that hinge leaf cover 100 may be snuggly secured on the hinge leaf. In some embodiments, knuckle portion 120 could have a different cross-sectional inner shape from the knuckle components. For example, knuckle portion 120 could have a square or rectangular cross-sectional shape.

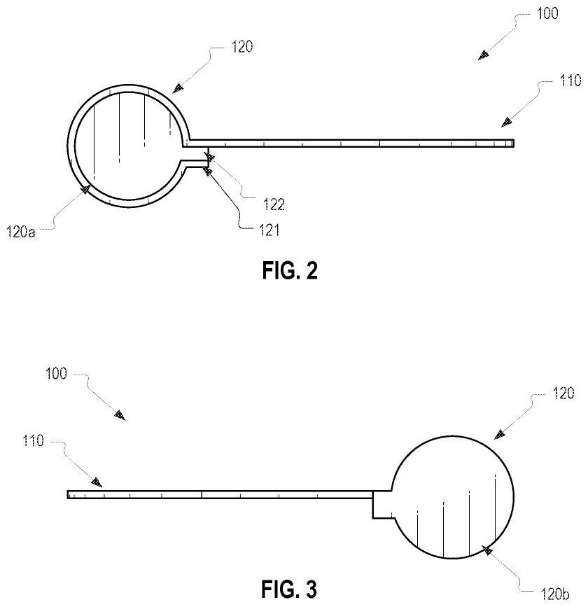

As is best seen in FIGS. 2 and 5, knuckle portion 120 may include an extension 121 that forms a channel 122 between extension 121 and leaf portion 110. Extension 121 may be configured to extend up to the edge of the door or door frame to which the hinge leaf is connected and may therefore mask the exposed back portion of the hinge leaf that extends beyond the door or door frame.

In some embodiments, a bottom 120a of knuckle portion 120 (including channel 122) is open while a top 120b is closed. With such a configuration, knuckle portion 120 can be slid down overtop the knuckle components of the leaf hinge (see, e.g., FIG. 9). In some embodiments, the closed top portion 120b may rest on the knuckle components to assist in positioning leaf portion 110 relative to the hinge leaf. Because the closed top portion 120b extends overtop the top of channel 122, top portion 120b may rest on the top of the hinge leaf such as in cases where the knuckle components are not positioned at the top of the hinge leaf. The closed top portion 120b may also protect the top of the knuckle components and the exposed top portion of the hinge leaf from paint.

Leaf portion 110 extends outwardly from knuckle portion 120 at an angle and from a position that causes leaf portion 110 to lie flat overtop the hinge leaf when knuckle portion 120 is secured to the knuckle components. Leaf portion 110 can be shaped and sized to match (or substantially match) the shape and size of a hinge leaf on a door or door frame to be painted. In the depicted embodiments, leaf portion 110 includes rounded outer corners and therefore matches the shape of hinge leaves that are commonly used on interior residential doors. In other embodiments, leaf portion 110 may not have rounded outer corners and may therefore match the shape of hinge leaves that are commonly used on exterior and non-residential doors. In short, leaf portion 110 could be shaped and sized for use on a wide variety of hinge leaves.

FIG. 9 provides an example of how hinge leaf cover 100 of FIGS. 1-7 can be slid overtop a left-hand hinge leaf 900 that is attached to a door or door frame 910. As shown, knuckle portion 120 can be aligned with knuckle components 901 with leaf portion 110 overtop hinge leaf 900. Then, knuckle portion 120 can be slid down overtop knuckle components 901 with channel 122 receiving the portion of hinge leaf 900 that extends beyond the edge of door or door frame 910. With closed top portion 120b resting on top of (or at least positioned at) the top knuckle component 901 and the top of the exposed portion of hinge leaf 900, leaf portion 110 will substantially align and cover hinge leaf 900. Door or door frame 910 can then be painted after which hinge leaf cover 100 can be removed and possibly reused.

In other embodiments, the knuckle portion of a hinge leaf cover could be configured to snap around the knuckle components as opposed to sliding overtop. For example, the knuckle portion could be formed of a sufficiently flexible and resilient material to allow channel 122 to be opened sufficiently to enable the knuckle components to pass through. In such embodiments, the top of extension 121 and the top of a portion of knuckle portion 120 may not be fixed to the closed top portion 120b to thereby enable this widening of channel 122.

A hinge leaf cover configured in accordance with embodiments of the present disclosure could be formed of any suitable material and could be formed as a unitary component or as multiple connectable components. As one example, closed top portion 120b could be a removable cover.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A hinge leaf cover comprising:
a knuckle portion configured to be secured to one or more knuckle components of a hinge leaf; and
a leaf portion that extends from the knuckle portion and is configured to cover the hinge leaf.

2. The hinge leaf cover of claim 1, wherein the knuckle portion is hollow and slides overtop the one or more knuckle components.

3. The hinge leaf cover of claim 2, wherein the knuckle portion is configured to cover each knuckle component of the hinge leaf.

4. The hinge leaf cover of claim 2, wherein the knuckle portion is cylindrical.

5. The hinge leaf cover of claim 2, wherein a top of the knuckle portion is closed and a bottom of the knuckle portion is open.

6. The hinge leaf cover of claim 5, wherein the knuckle portion includes an extension that is spaced from the leaf portion to thereby form a channel between the extension and the leaf portion.

7. The hinge leaf cover of claim 6, wherein a top of the channel is closed and a bottom of the channel is open.

8. The hinge leaf cover of claim 1, wherein a shape and size of the leaf portion matches a shape and size of the hinge leaf.

9. A hinge leaf cover comprising:
a knuckle portion; and
a leaf portion that extends from the knuckle portion;
wherein the knuckle portion includes an extension that is spaced from the leaf portion to form a channel.

10. The hinge leaf cover of claim 9, wherein the knuckle portion extends from a top of the leaf portion to a bottom of the leaf portion.

11. The hinge leaf cover of claim 10, wherein the extension extends from the top of the leaf portion to the bottom of the leaf portion.

12. The hinge leaf cover of claim 9, wherein the knuckle portion is hollow.

13. The hinge leaf cover of claim 12, wherein a top of the knuckle portion is covered.

14. The hinge leaf cover of claim 13, wherein a top of the channel is covered.

15. The hinge leaf cover of claim 13, wherein a bottom of the knuckle portion is open.

16. The hinge leaf cover of claim 9, wherein the knuckle portion is cylindrical.

17. The hinge leaf cover of claim 9, wherein the knuckle portion is configured to slide overtop one or more knuckle components of a hinge leaf.

18. The hinge leaf cover of claim 9, wherein the knuckle portion is configured to selectively couple to one or more knuckle components of a hinge leaf.

19. A paint masking solution comprising:
a left-hand hinge leaf cover for masking a left-hand hinge leaf of a hinge, the left-hand hinge leaf cover comprising a knuckle portion configured to be secured to one or more knuckle components of the left-hand hinge leaf and a leaf portion that extends from the knuckle portion; and
a right-hand hinge leaf cover for masking a right-hand hinge leaf of the hinge, the right-hand hinge leaf cover comprising a knuckle portion configured to be secured to one or more knuckle components of the right-hand hinge leaf and a leaf portion that extends from the knuckle portion.

20. The paint masking solution of claim 19, wherein the left-hand hinge leaf cover is a mirror image of the right-hand hinge leaf cover.
